(19) United States
(12) Patent Application Publication
(10) Pub. No.: US 2004/0217086 A1
(43) Pub. Date: Nov. 4, 2004

(54) Pattern formation method

(75) Inventor: Koichi Kawashima, Osaka (JP)

Correspondence Address: Jack Q. Lever, Jr., McDERMOTT, WILL & EMERY, 600 Thirteenth Street, N. W., Washington, DC, 20005-3096, US

(73) Assignee: Matsushita Electric Industrial Co., Ltd.

(21) Appl. No.: 10/653,200

(22) Filed: Sep. 3, 2003

(30) Foreign Application Priority Data
Nov. 9, 2002 (JP) 2002-265391

(51) Int. Cl. B44C 1/22

(52) U.S. Cl. 216/41

(57) ABSTRACT

A wafer provided with a resist pattern is placed in a dry etching apparatus, and a silicon nitride film is dry-etched using the resist pattern as a mask. Thus, a first deposit deposited on a side face of the resist pattern facing inwardly with respect to the center of the wafer, and a second deposit deposited on a side face of the resist pattern facing outwardly are both relatively thickly adhered. An etching gas used in this case is a gas mixture containing SF₆, CHF₃ and Ar.

### BACKGROUND OF THE INVENTION

The present invention relates to a patterning method for patterning a film to be etched by using a resist pattern as a mask, and more particularly relates to a patterning method for performing dry etching by using a resist pattern formed out of a resist material sensitive to an exposure light having a wavelength equal to or shorter than that of ArF excimer laser.

As a fine patterning method for providing semiconductor integrated circuit elements, generally employed is a method in which a mask pattern is formed out of a resist material, and etching is performed using the pattern as a mask, thereby forming a desired circuit element pattern in a film to be etched.

In this case, the circuit element pattern is formed by etching the film to be etched almost perpendicularly with respect to the principal surface thereof (i.e., anisotropic etching is performed) so that the size of the pattern is substantially equal to that of the mask pattern.

Hereinafter, a conventional patterning method in which insulating films are to be etched will be described with reference to FIGS. 11(a) through 11(e) (see, e.g., “Semiconductor Dry Etching Technique” written by Takashi Tokuyama and published by Sangyo Tosho Publishing Co., Ltd., Oct. 1992, pp.81-89).

First, as shown in FIG. 11(a), a thermal oxidation or vapor phase epitaxy process, for example, is carried out to form a silicon oxide film 102 with a thickness of about 20 nm on a wafer 101 made of silicon, and then a chemical vapor deposition (CVD) process, for example, is performed to sequentially deposit, over the silicon oxide film 102, a polysilicon film 103 with a thickness of about 20 nm and a silicon nitride film 104 with a thickness of about 120 nm.

Next, as shown in FIG. 11(b), an antireflection film 105 for preventing reflection due to exposure is formed on the silicon nitride film 104. The antireflection film 105 is formed out of a silicon oxide nitride film by a plasma CVD process, for example, and its suitable thickness is about 40 nm. Alternatively, the antireflection film 105 may be formed using an organic film; in that case, its suitable thickness is about 80 nm and the film may be deposited by a coating process.

Subsequently, a resist film 106A that is sensitive to KrF excimer laser and has a thickness of about 550 nm is applied to the antireflection film 105, a photomask (not shown) in which a circuit pattern for a semiconductor device is formed is properly positioned above the resist film 106A, and then the resist film 106A is exposed to an exposure light that has been passed through the photomask.

Next, as shown in FIG. 11(c), the exposed resist film 106A is developed to provide a resist pattern 106.

Then, as shown in FIG. 11(d), the antireflection film 105 and the silicon nitride film 104 are dry-etched by using the provided resist pattern 106 as an etching mask and utilizing a predetermined etching gas. By mainly utilizing, as the etching gas, a gas mixture containing a gas having an etching action and a gas that produces deposits from reaction products during the etching, deposits 107 are adhered to the side faces of the films to be etched (i.e., the antireflection film 105 and the silicon nitride film 104) which are being patterned during the etching. In this case, if the amount of the deposits 107 and the etch rate resulting from the etching gas are in balance, it becomes possible to obtain the silicon nitride film 104 having a pattern shape substantially perpendicular to the substrate face.

In recent years, the miniaturization of semiconductor elements in a semiconductor integrated circuit is being more and more advanced, and in accordance with this, the wavelength of an exposure light for providing a resist pattern is becoming shorter and shorter. Depending on the size required for a circuit pattern, for example, an emission line of a mercury lamp such as g-line (with a wavelength of 436 nm) or i-line (with a wavelength of 365 nm) has conventionally been used, and furthermore, KrF excimer laser (with a wavelength of 248 nm) has been used instead of an emission line of a mercury lamp.

However, in order to carry out exposure for a circuit pattern having a line width smaller than 130 nm, it is impossible to use KrF excimer laser having a wavelength of 248 nm. Therefore, as an exposure light for providing a finer circuit pattern, ArF excimer laser having a wavelength of 194 nm, for example, is about to be used.

As a resist sensitive to g-line or i-line, a benzene ring-containing resin material such as novolac, which is a material having resistance to etching, is used, and if this resin material is used with ArF excimer laser, the resin material exhibits a high absorption in the wavelength range of the laser. Accordingly, as a resist material sensitive to ArF excimer laser, an acrylic resin material is often used.

The strength of an acrylic resin material, however, is not as high as that of a benzene ring-containing resin material; therefore, even if a good pattern shape is obtained right after development, there arises the problem that a resist pattern tilts during etching, i.e., a so-called “resist tilting”.

Besides, as for the aspect ratio of a resist pattern, a resist material sensitive to KrF excimer laser has an aspect ratio of about 3, whereas a resist material sensitive to ArF excimer laser, which is often used, has an aspect ratio of about 4. In this respect also, a resist material sensitive to ArF excimer laser is more likely to cause resist tilting than a resist material sensitive to KrF excimer laser.

### SUMMARY OF THE INVENTION

In view of the above-described prior art problems, an object of the present invention is not only to surely obtain an anisotropic shape in a film to be etched while preventing resist tilting but also to make it possible to adjust a pattern size in an etching process that uses a resist pattern formed out of a resist material sensitive to ArF excimer laser.

To achieve the above object, the present invention provides a patterning method that uses a resist pattern formed out of a resist material sensitive to an exposure light having a wavelength equal to or shorter than that of ArF excimer laser light, in which method etching is performed while relatively thick deposits are being deposited on both side faces of the resist pattern which are at least perpendicular to a radial direction of a wafer, or etching is performed so that no deposits are deposited on said both side faces.

The present inventors have conducted various studies on resist tilting that occurs while etching is performed using a resist pattern formed out of a resist material sensitive to an exposure light having a wavelength equal to or shorter than that of ArF excimer laser light; as a result, the present inventors have found causes of resist tilting and obtained findings as described below.

FIG. 1 shows, in the case where a resist pattern resulting from exposure to ArF excimer laser is used, a graph on which each pattern shift is plotted with the initial value of a resist pattern size varied for five etching conditions (A through E). In the graph, the “resist pattern size” refers to a line width of a pattern having a linear shape, and furthermore, the pattern shift values associated with the same etching condition are connected with a straight line.

As shown in FIG. 1, suppose that etching is performed under the etching condition A or C in which the pattern shift is about 4 nm to about 10 nm. In that case, it can be seen that if the initial value of the resist pattern is smaller than 130 nm, the resist tilting occurs in any pattern. On the other hand, suppose that etching is performed under the etching condition D in which the pattern shift is equal to or larger than 20 nm, or under the etching condition E in which the pattern shift is about −15 nm. In either case, it can be seen that the resist tilting does not occur.

Hereinafter, for the sake of comparison, description will be made about the case where a resist pattern resulting from exposure to KrF excimer laser is used.

FIG. 2 shows, in the case where a resist pattern resulting from exposure to KrF excimer laser is used, a graph on which each pattern shift is plotted with the initial value of a resist pattern size varied for five etching conditions (1 through 5). In this graph, the pattern shift values associated with the same etching condition are also connected with a straight line.

As shown in FIG. 2, if a resist pattern resulting from exposure to KrF excimer laser is used, no resist tilting occurs in any resist pattern, and it is possible to complete the resist pattern size so that the pattern shift is within ±10 nm with respect to a desired resist pattern size.

The pattern shift value is proportional to the amount of deposits adhered to sidewalls during etching. Therefore, the condition in which the pattern shift is large corresponds to the etching condition in which the amount of deposits deposited on the sidewalls of a resist pattern (i.e., sidewall deposits) is relatively large. Accordingly, as can be seen from FIG. 1, if a resist sensitive to ArF excimer laser is used, the resist tilting is prevented from occurring by making the amount of sidewall deposits produced during etching larger than an etched amount, or by making the amount of the sidewall deposits smaller than the etched amount.

Primarily, the resist tilting occurs when stresses applied to both sides of a resist pattern are different in magnitude and a stress that surpasses the strength of the resist is applied thereto. The source of stresses applied to a resist pattern is thought to be produced by the self-contraction of the resist pattern mainly due to the heat thereof It should be noted that a phenomenon that a resist pattern is contracted by being overheated due to exposure to ions during etching is well known.

As shown in FIG. 3(a), linear patterns (line patterns) generally include: first line patterns 104A each located perpendicularly to a radial direction of a wafer 101; and second line patterns 104B each located parallel to a radial direction. In each first line pattern 104A located perpendicularly to a radial direction, the amount of adherence of deposit is large on a side face that faces the inward of the wafer 101, and the amount of adherence of the deposit is small on a side face that faces the outward of the wafer 101. In addition, the difference between the amounts of adherence is particularly pronounced at a peripheral portion of the wafer 101. More specifically, suppose that a central line including a notch 101a used to determine a crystal orientation in the wafer 101 is defined as an X-axis, for example, as shown in FIG. 3(a); in that case, among the first line patterns 104A each having side faces intersecting a Y-axis orthogonal to the X-axis, each pattern formed at the peripheral portion of the wafer 101 has a larger amount of deposit adhered on its inward side face. Similarly, in the case shown in FIG. 3(b), among the first line patterns 104A and the second line patterns 104B, i.e., among the first line patterns 104A each having side faces intersecting the X-axis, each pattern formed at the peripheral portion of the wafer 101 has a larger amount of deposit adhered on its inward side face.

Hereinafter, in addition to a phenomenon that a resist contracts, how the resist tilting occurs will be described in detail with reference to the cross-sectional views in FIGS. 4(a) through 4(d).

First, as shown in FIG. 4(a), a resist pattern 108 resulting from exposure to ArF excimer laser is provided over a silicon nitride film 104 formed over a wafer 101, with an antireflection film 105 interposed between the silicon nitride film 104 and the resist pattern 108.

Suppose that the left side of FIG. 4(b) is closer to the center (inward) of the wafer 101. In that case, if the antireflection film 105 and the silicon nitride film 105 are dry-etched using the resist pattern 108 as a mask, a first deposit 107A deposited on an inward side face of the resist pattern 108 is adhered more thickly than a second deposit 107B deposited on an outward side face of the resist pattern 108. It should be noted that the amounts of adherence of the deposits are inevitably out of balance in the pattern in which distances (spaces) each located between lines adjacent to each other are out of balance.

Next, as shown in FIG. 4(c), suppose that the resist pattern 108, to which the first and second deposits 107A and 107B different in thickness are adhered, is contracted due to a temperature increase. In that case, if the stress resistance of the second deposit 107B, the amount of which is small, for supporting the resist and the stress resistance of the resist itself are smaller than a stress caused by contraction, the resist tilting occurs, and the continuation of the etching in this state results in the situation shown in FIG. 4(d).

Based on this phenomenon, a first finding for preventing the resist tilting will be described with reference to FIGS. 5(a) through 5(d).

First, as shown in FIG. 5(a), a resist pattern 108 resulting from exposure to ArF excimer laser is provided over a silicon nitride film 104 formed over a wafer 101, with an antireflection film 105 interposed between the silicon nitride film 104 and the resist pattern 108.

Next, as shown in FIG. 5(b), the antireflection film 105 and the silicon nitride film 105 are dry-etched under the condition such as the etching condition D shown in FIG. 1, for example, so that sidewall deposits are considerably increased. In this manner, the amount of the second deposit 107B deposited on an outward side face of the resist pattern 108 is also increased.

Thus, as shown in FIG. 5(c), even if the resist pattern 108 is contracted, the second deposit 107B can endure contraction stress of the resist pattern 108 since the stress resistance of the second deposit 107B is sufficiently increased. Consequently, if the etching is allowed to proceed further by using, as a mask, the resist pattern 108 that has not tilted but contracted, a circuit pattern can be formed without causing the resist tilting as shown in FIG. 5(d). However, in this case, there occurs a pattern shift corresponding to the amounts of the deposits 107A and 107B each having a thickness that provides the strength to endure a stress applied thereto.

Hereinafter, a second finding for preventing the resist tilting will be described with reference to FIGS. 6(a) through 6(d).

First, as shown in FIG. 6(a), a resist pattern 108 resulting from exposure to ArF excimer laser is provided over a silicon nitride film 104 formed over a wafer 101, with an antireflection film 105 interposed between the silicon nitride film 104 and the resist pattern 108.

Next, as shown in FIG. 6(b), the antireflection film 105 and the silicon nitride film 105 are dry-etched under the condition such as the etching condition B or E shown in FIG. 1, for example, so that almost no sidewall deposits are adhered. Therefore, in this case, an imbalanced adhesion of the deposits to both sidewalls of the resist pattern 108 does not occur.

Then, as shown in FIG. 6(c), even if the resist pattern 108 is contracted during the etching, the difference between the stress resistances of the sidewall deposits due to the difference between the amounts thereof does not occur, and therefore, a stress that causes the resist tilting is not applied to the resist pattern 108. It is to be noted that this effect is obtained based on the premise that the cross-sectional shape of the resist pattern 108 is not an easily tiltable shape such as a reversed taper shape.

Subsequently, as shown in FIG. 6(d), if the etching is allowed to proceed further by using, as a mask, the resist pattern 108 that has not tilted but contracted, a circuit pattern can be formed without causing the resist tilting.

It should be noted that since an imbalanced deposition of the sidewall deposits on both side faces of the resist pattern 101, which are parallel to a radial direction of the wafer 101, does not occur in the first place, and thus no problem is caused.

A patterning method according to the present invention has been made based on these findings, and in this method, sidewall deposits of a resist pattern are thickened during dry etching to the extent that they can endure stresses applied thereto, or the dry etching is performed under the etching condition in which almost no sidewall deposits are deposited.

More specifically, a first patterning method according to the present invention includes: a first step of forming a film to be etched over a wafer; a second step of providing, on the film to be etched, a resist pattern formed out of a resist material sensitive to ArF excimer laser light or an exposure light having a wavelength shorter than that of ArF excimer laser light; and a third step of etching the film to be etched by using the resist pattern as a mask, wherein in the third step, the film to be etched is etched while relatively thick deposits are being deposited on both side faces of the resist pattern which are at least perpendicular to a radial direction of the wafer.

According to the first patterning method, even if thermal contraction of the resist pattern occurs, the relatively thick deposits are increased in stress resistance and are substantially in balance on both side faces of the resist pattern, which can prevent the resist tilting, and therefore, the film to be etched can have an anisotropic shape.

In the first patterning method, the etching in the third step is preferably performed so that a pattern size obtained after the etching of the film to be etched is larger than a predetermined size.

In the first patterning method, a pattern shift resulting from the etching of the film to be etched is preferably +20% to +80%.

A second patterning method according to the present invention includes: a first step of forming a film to be etched over a wafer; a second step of providing, on the film to be etched, a resist pattern formed out of a resist material sensitive to ArF excimer laser light or an exposure light having a wavelength shorter than that of ArF excimer laser light; and a third step of etching the film to be etched by using the resist pattern as a mask, wherein in the third step, the film to be etched is etched so that no deposits are deposited on both side faces of the resist pattern which are at least perpendicular to a radial direction of the wafer.

According to the second patterning method, even if thermal contraction of the resist pattern occurs, no deposits are deposited on both side faces of the resist pattern, and stresses applied to the resist pattern are not out of balance; therefore, the resist tilting can be prevented, and as a result, the film to be etched can have an anisotropic shape.

In the second patterning method, the etching in the third step is preferably performed so that a pattern size obtained after the etching of the film to be etched is smaller than a predetermined size.

In such an embodiment, a pattern shift resulting from the etching of the film to be etched is preferably ±0% to −30%.

A third patterning method according to the present invention includes: a first step of forming a film to be etched; a second step of providing, on the film to be etched, a resist pattern formed out of a resist material sensitive to ArF excimer laser light or an exposure light having a wavelength shorter than that of ArF excimer laser light; and a third step of etching the film to be etched by using the resist pattern as a mask, wherein the third step includes the steps of: (a) etching the film to be etched while depositing relatively thick deposits on both side faces of the resist pattern; and (b) etching the film to be etched so that no deposits are deposited on said both side faces of the resist pattern.

According to the third patterning method, even if a pattern shift value is increased due to the relatively thick deposits in the step (a), the pattern shift value becomes negative in the subsequent step (b), and therefore, a desired pattern size can be obtained.

In the third patterning method, the film to be etched is preferably formed over a wafer, and said both side faces of the resist pattern are preferably at least perpendicular to a radial direction of the wafer.

In such an embodiment, it is preferable that in the step (a) of the third step, the etching is performed so that a pattern size obtained after the etching of the film to be etched is larger than a predetermined size, and it is preferable that in the step (b) of the third step, an etching condition for the film to be etched is set so that the deposits are etched, and the etching is performed so that the pattern size obtained after the etching of the film to be etched is smaller than a predetermined size.

In such an embodiment, a pattern shift resulting from the etching of the film to be etched is preferably ±0% to +20%.

In the first or third patterning method, it is preferable that the film to be etched is made of silicon, silicon compound, carbon or carbon compound, and it is preferable that in performing the etching while depositing the relatively thick deposits in the third step, SF₆ is used as a first etching gas for allowing the etching to proceed, at least one of CF₄, CHF₃, CH₂F₂ and CH₄ is used as a second etching gas for producing the deposits on the side faces of the resist pattern, and Ar, He, Ne or Xe is used as a dilution gas for diluting the first etching gas and the second etching gas.

In the second or third patterning method, it is preferable that the film to be etched is made of silicon, silicon compound, carbon or carbon compound, and it is preferable that in performing the etching so that no deposits are deposited in the third step, etching gases used include: a first etching gas for allowing the etching to proceed; a second etching gas for allowing the etching to proceed and for producing the deposits; a third etching gas for producing the deposits; and a fourth etching gas for etching the deposits, a first gas mixture provided by the combination of: the first or second etching gas; the third etching gas; and the fourth etching gas, or a second gas mixture provided by the combination of: the first or second etching gas; and the fourth etching gas is used, the first etching gas is SF₆, the second etching gas is CF₄ or CHF₃, the third etching gas is at least one of CH₂F₂ and CH₄, and the fourth etching gas is at least one of SF₆, O₂, O₃, CO and CO₂, and Ar, He, Ne or Xe is used as a dilution gas for diluting the first gas mixture and the second gas mixture.

### BRIEF DESCRIPTION OF THE DRAWINGS

FIG. 1 is a graph showing the relationship between the initial value of a resist pattern size and a pattern shift and the relationship between the pattern shift and resist tilting for each etching condition in the case where a resist sensitive to ArF excimer laser is used.

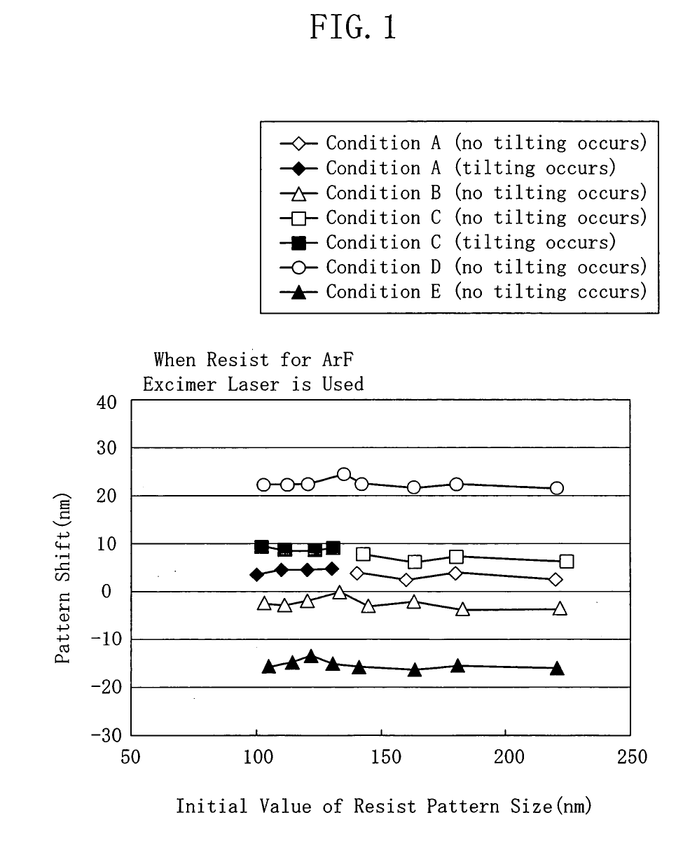

FIG. 2 is a graph for comparison showing the relationship between the initial value of a resist pattern size and a pattern shift for each etching condition in the case where a resist sensitive to KrF excimer laser is used.

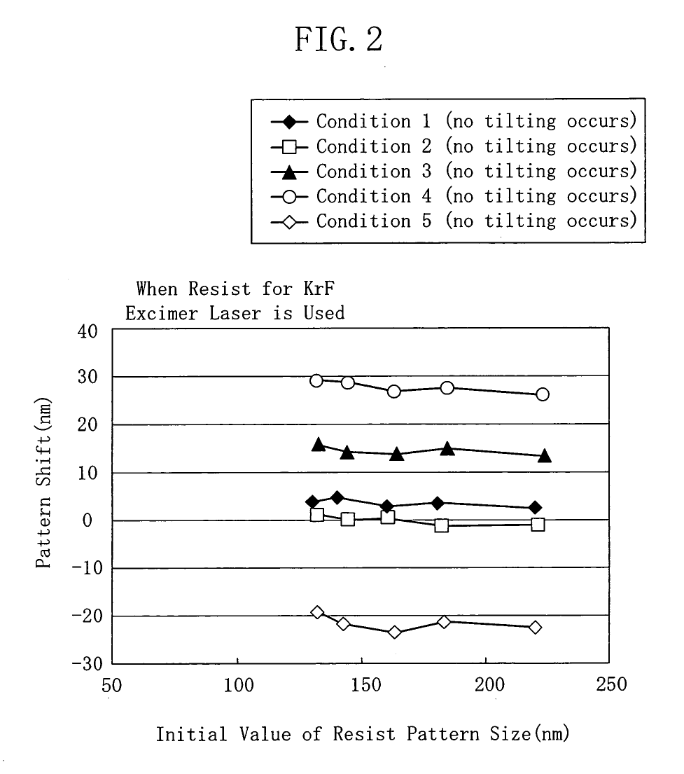

FIGS. 3(a) and 3(b) are schematic plan views each showing the orientation of each line pattern over the principal surface of a wafer.

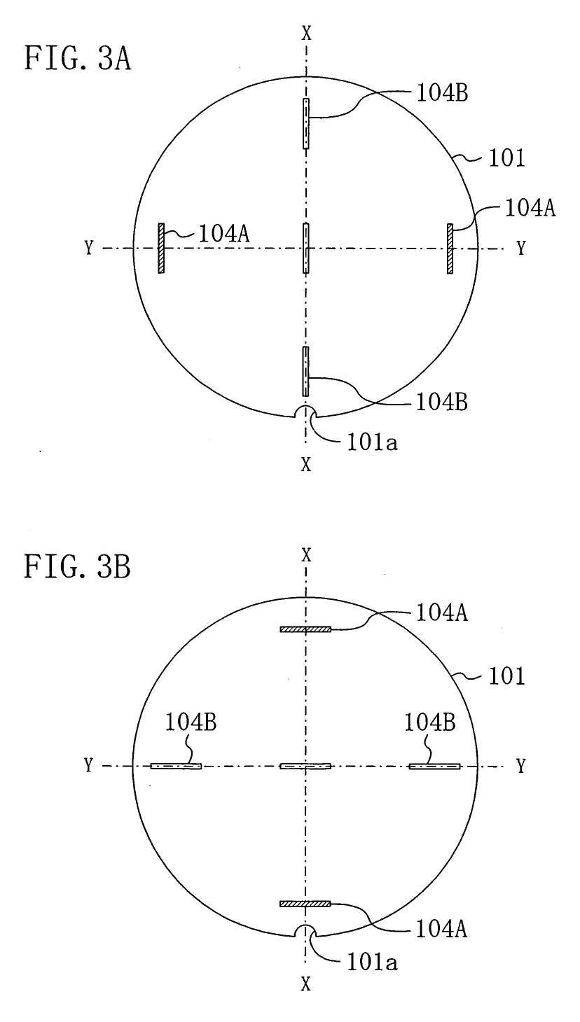

FIG. 4 shows schematic cross-sectional views for sequentially illustrating respective steps of occurrence of resist tilting in a patterning process in the case where a resist sensitive to ArF excimer laser is used.

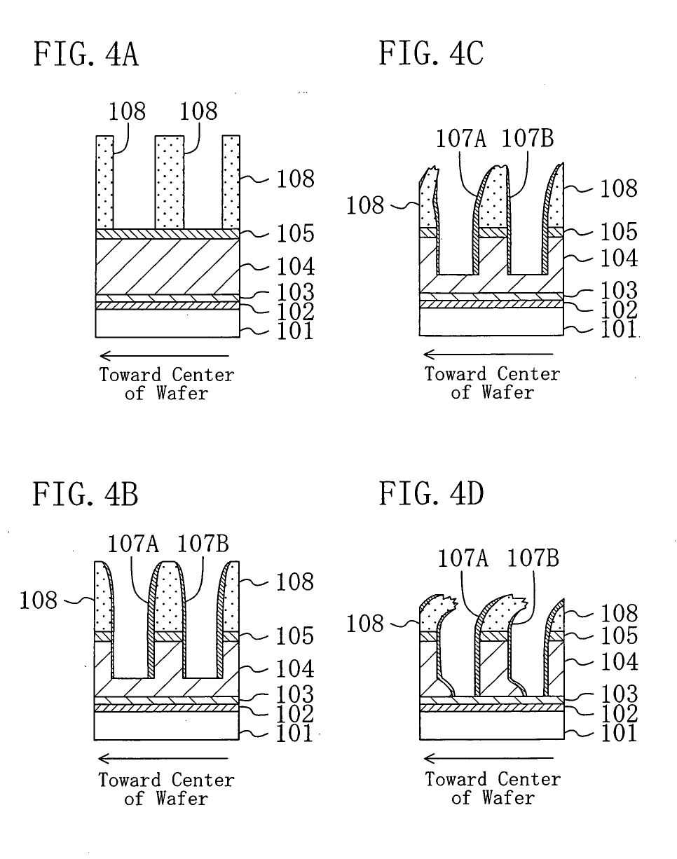

FIG. 5 shows schematic cross-sectional views for sequentially illustrating respective steps of a first method for preventing resist tilting in a patterning process according to the present invention in the case where a resist sensitive to ArF excimer laser is used.

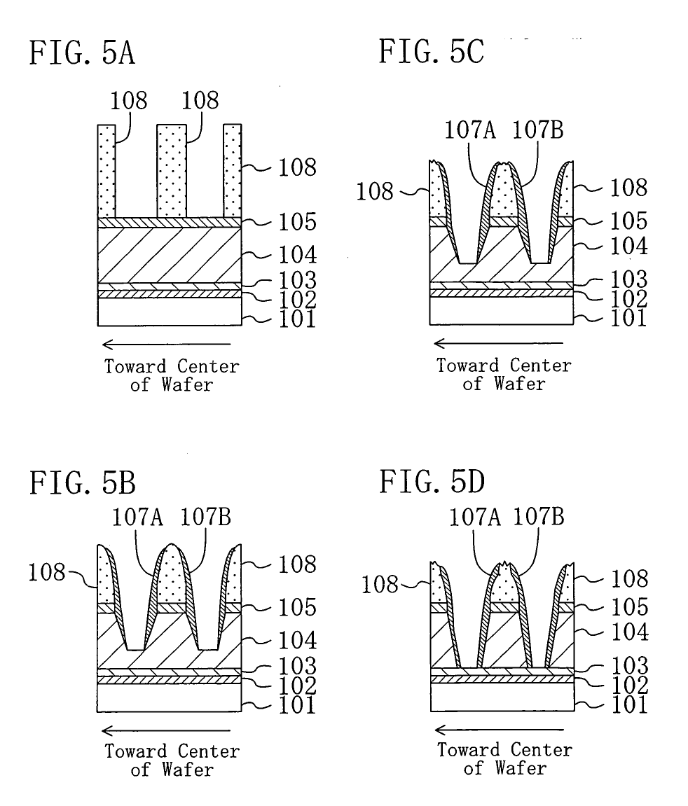

FIG. 6 shows schematic cross-sectional views for sequentially illustrating respective steps of a second method for preventing resist tilting in a patterning process according to the present invention in the case where a resist sensitive to ArF excimer laser is used.

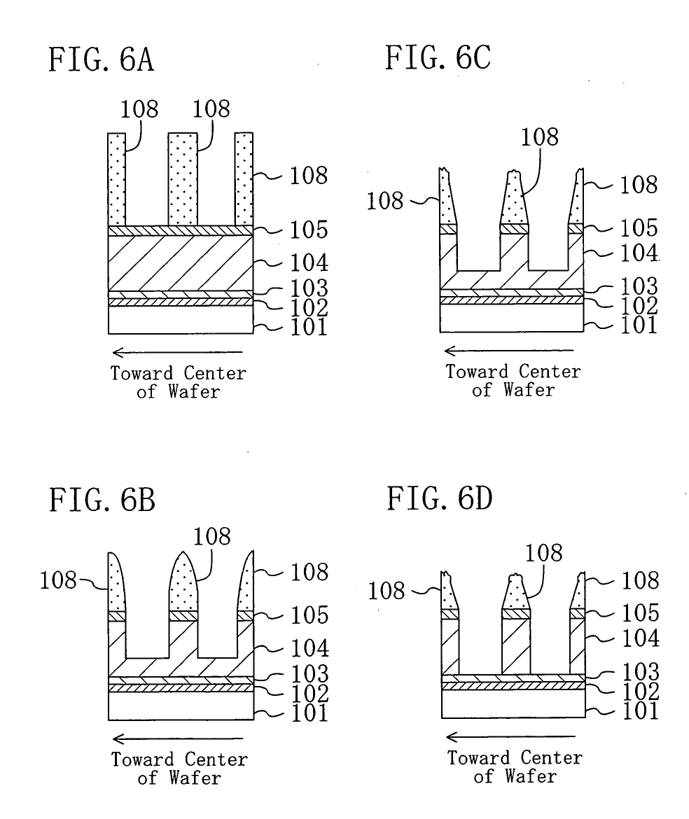

FIG. 7 is a schematic cross-sectional view showing a dry etching apparatus used in a patterning method of the present invention.

FIG. 8 shows partial schematic cross-sectional views of a wafer for sequentially illustrating respective steps of a patterning method according to a first embodiment of the present invention.

FIG. 9 shows partial schematic cross-sectional views of a wafer for sequentially illustrating respective steps of a patterning method according to a second embodiment of the present invention.

FIG. 10 shows partial schematic cross-sectional views of a wafer for sequentially illustrating respective steps of a patterning method according to a third embodiment of the present invention.

FIG. 11 shows schematic cross-sectional views for sequentially illustrating respective steps of a conventional patterning method.

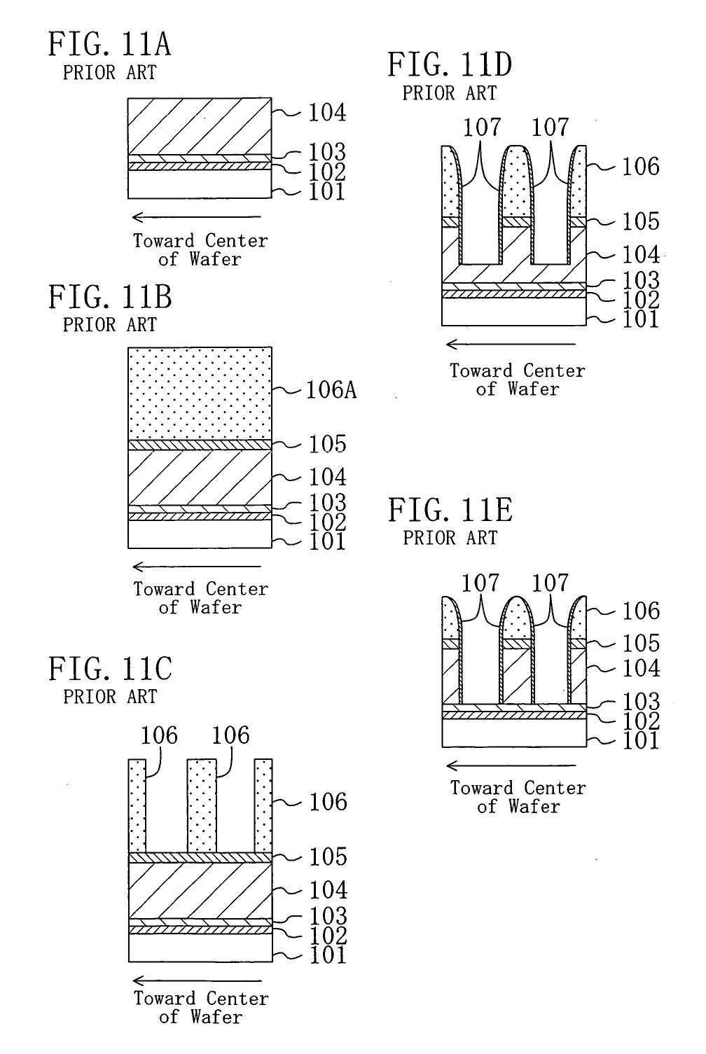

### DESCRIPTION OF THE PREFERRED EMBODIMENTS

### First Embodiment

First, a dry etching apparatus used in a patterning method according to a first embodiment of the present invention will be schematically described.

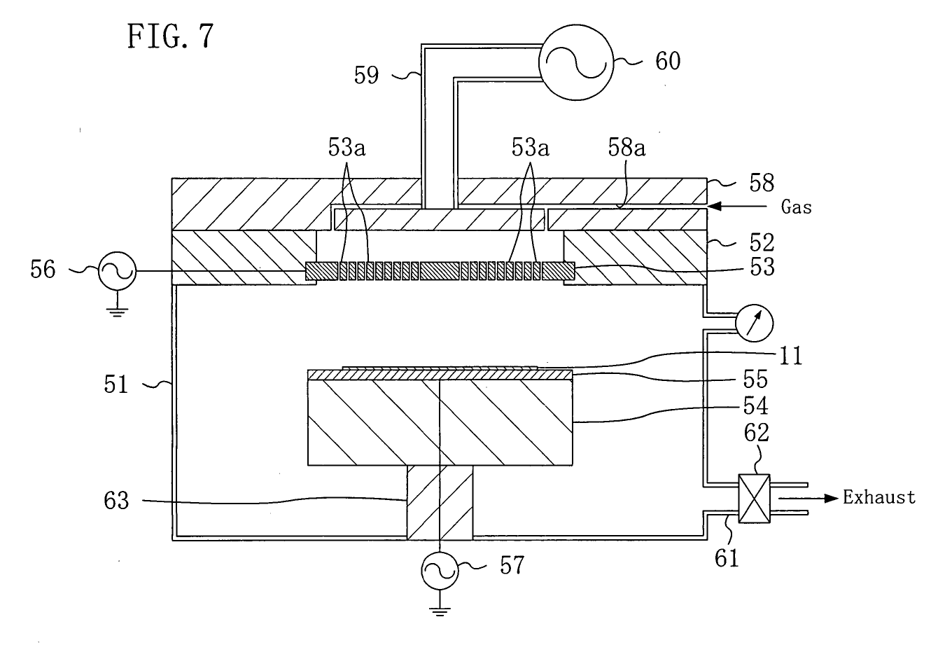

A dry etching apparatus shown in FIG. 7 is one that employs UHF (Ultra High Frequency)-ECR (Electron Cyclotron Resonance) plasma technique, and as shown in FIG. 7, a reaction chamber 51 is provided with: an upper electrode 53 that is held by an upper electrode holding member 52 and is formed with a plurality of holes 53a vertically passing therethrough; and a lower electrode 55 that is held on a holding table 54 and that holds a wafer 11 placed on the upper surface of the lower electrode 55, with the upper and lower electrodes 53 and 55 spaced apart from each other and opposite to each other.

The upper electrode 53 is electrically connected to a first high-frequency power supply 56, and the lower electrode 55 is electrically connected to a second high-frequency power supply 57.

The reaction chamber 51 is hermetically provided at its upper portion with a lid member 58 for covering the upper electrode holding member 52 and the upper electrode 53. The lid member 58 is provided at its inside with a gas introduction hole 58a whose exits are open to a space above the upper electrode 53.

Provided on the lid member 58 and above the center of the upper electrode 53 is a waveguide 59 through which an electromagnetic wave is propagated, and an end of the waveguide 59 opposite to the lid member 58 is connected with a electromagnetic wave generator 60 for generating a UHF wave.

Provided at a lower region of a side face of the reaction chamber 51 is an exhaust hole 61 through which a gas inside the reaction chamber 51 is exhausted, and with an exhaust pump 62 provided at the exhaust hole 61, the reaction chamber 51 is maintained under a predetermined vacuum.

The holding table 54 for holding the lower electrode 55 is supported, at its lower portion, by the supporting member 63, and the supporting member 63 has a mechanism for vertically moving the holding table 54 so that the wafer 11 is located at an optimum position in accordance with the density of plasma produced inside the reaction chamber 51.

Hereinafter, with reference to the drawings, a detailed description will be made about an example in which the dry etching apparatus with the above-described arrangement is used and a resist pattern with a line width of 100 nm is utilized, thereby forming, out of films to be etched, a circuit pattern with a pattern shift value of about 30 nm.

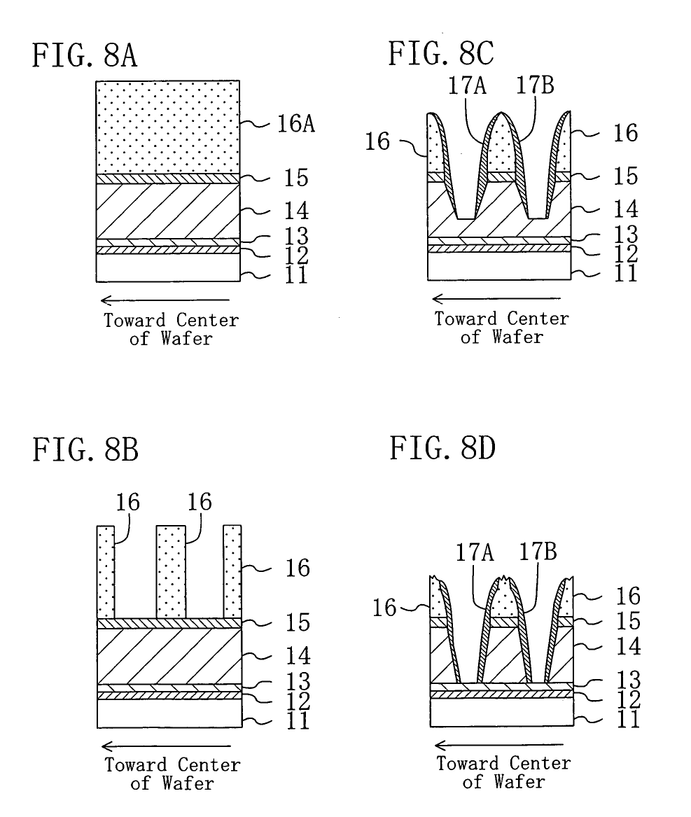

FIGS. 8(a) through 8(d) show partial cross-sections of a wafer for sequentially illustrating respective steps of the patterning method according to the first embodiment of the present invention.

First, as shown in FIG. 8(a), a thermal oxidation or vapor phase epitaxy process, for example, is carried out to form a silicon oxide film 12 with a thickness of about 20 nm on a wafer 11 made of silicon, and then a chemical vapor deposition (CVD) process, for example, is performed to sequentially deposit, over the silicon oxide film 12, a polysilicon film 13 with a thickness of about 20 nm and a silicon nitride film 14 with a thickness of about 120 nm. Thereafter, on the silicon nitride film 14, an antireflection film 15 for preventing reflection of an exposure light is formed. The antireflection film 15 is formed out of a silicon oxide nitride film by a plasma CVD process, for example, and its suitable thickness is about 40 nm. Alternatively, the antireflection film 15 may be formed using an organic film by a coating process; in that case, its suitable thickness is about 80 nm. Subsequently, a resist film 16A that is sensitive to ArF excimer laser and has a thickness of about 400 nm is applied to the antireflection film 15, a photomask (not shown) in which a circuit pattern for a semiconductor device is formed is properly positioned above the resist film 16A, and then the resist film 16A is exposed to an exposure light that has been passed through the photomask.

Next, as shown in FIG. 8(b), the exposed resist film 16A is developed to provide a resist pattern 16. In this embodiment, each cross section of the resist pattern 16A shown is extending perpendicularly to a radial direction of the wafer 11.

Then, as shown in FIG. 8(c), the wafer 11 provided with the resist pattern 16 is placed in the dry etching apparatus, and the antireflection film 15 and the silicon nitride film 14 are dry-etched by using the resist pattern 16 as an etching mask. An etching gas utilized in this case is a gas mixture containing sulfur hexafluoride (SF₆), trifluoromethane (CHF₃) and argon (Ar), for example.

The ratio between a reactive gas and a non-reactive gas for diluting the reactive gas, i.e., the value obtained from (SF₆+CHF₃)/Ar, is adjusted in the range of 0.04 to 0.1, while the ratio between sulfur hexafluoride and trifluoromethane, i.e., the value obtained from (SF₆/CHF₃), is adjusted in the range of 1 to 2.5.

The pressure in the reaction chamber 51 is adjusted in the range of 0.5 Pa to 4 Pa, the electric power for UHF wave generated by the electromagnetic wave generator 60 is adjusted in the range of 200 W to 1000 W, the RF electrical power applied to the upper electrode 53 is adjusted in the range of 100 W to 800 W, and the RF electrical power applied to the lower electrode 55 is adjusted in the range of 50 W to 800 W.

The temperature of the lower electrode 55 is adjusted in the range of −20° C. to 40° C., the temperature of wall face of the reaction chamber 51 is adjusted in the range of 0° C. to 60° C., and the distance between the upper electrode 53 and the lower electrode 55 is adjusted in the range of 10 mm to 120 mm.

In the first embodiment, an etching condition is set so that a pattern shift is about 30 nm.

In the following, exemplary specifics of the etching condition are enumerated.

| | |
|---|---|
| Flow rate of reactive gas (SF₆): | 40 ml/min |
| Flow rate of reactive gas (CHF₃): | 20 ml/min |
| Flow rate of dilution gas (Ar): | 1000 ml/min |
| Pressure in reaction chamber: | 2 Pa |
| Electric power for UHF wave: | 600 W |
| RF electrical power to upper electrode: | 400 W |
| RF electrical power to lower electrode: | 150 W |
| Temperature of lower electrode: | 20° C. |
| Temperature of wall face of reaction chamber: | 30° C. |
| Distance between electrodes: | 30 mm |

By employing this etching condition, a first deposit 17A deposited on an inward side face of the resist pattern 16 and a second deposit 17B deposited on an outward side face of the resist pattern 16 are both relatively thickly adhered as shown in FIG. 8(c).

Consequently, as shown in FIG. 8(d), even if the resist pattern 16 is contracted due to exposure to ions during the etching, the thicknesses of the first deposit 17A and the second deposit 17B deposited oppositely on both side faces of the resist pattern 16 are substantially in balance; therefore, the resistances of both the deposits 17a and 17B to stresses are also in balance, which prevents the occurrence of the resist tilting.

Furthermore, even if the pattern shift value is larger than 30 nm, it is possible to similarly prevent the resist tilting by modifying a parameter value in the etching condition within a predetermined adjustment range, and therefore, a desired pattern size is realized.

### Second Embodiment

Hereinafter, with reference to the drawings, description will be made about a second embodiment of the present invention, i.e., a patterning method in which the dry etching apparatus shown in FIG. 7 is used and a resist pattern with a line width of 100 nm is utilized, thereby forming, out of films to be etched, a circuit pattern with a pattern shift value of about −10 nm.

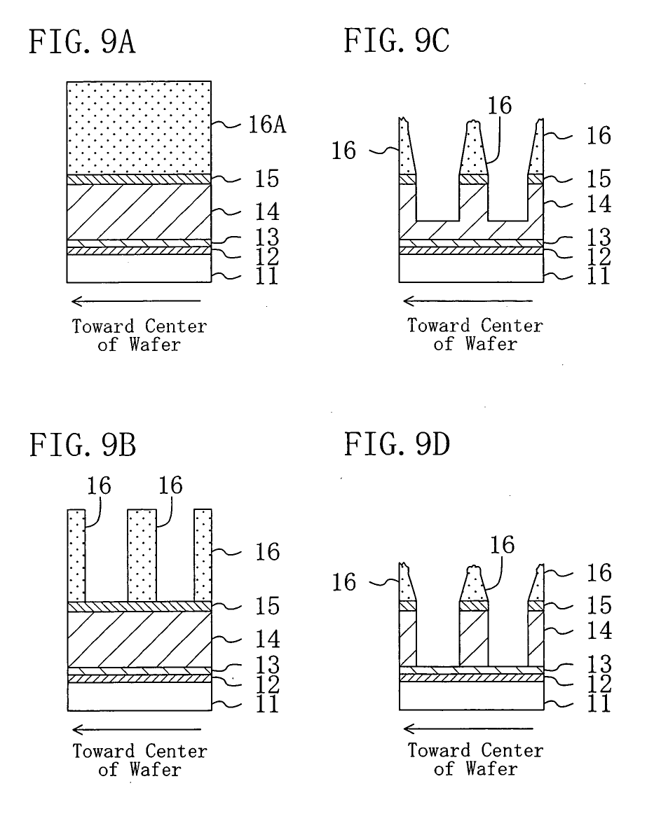

FIGS. 9(a) through 9(d) show partial cross-sections of a wafer for sequentially illustrating respective steps of the patterning method according to the second embodiment of the present invention.

First, as shown in FIG. 9(a), a thermal oxidation or vapor phase epitaxy process, for example, is carried out to form a silicon oxide film 12 with a thickness of about 20 nm on a wafer 11 made of silicon, and then a CVD process, for example, is performed to sequentially deposit, over the silicon oxide film 12, a polysilicon film 13 with a thickness of about 20 nm and a silicon nitride film 14 with a thickness of about 120 nm. Thereafter, on the silicon nitride film 14, an antireflection film 15 for preventing reflection of an exposure light is formed. The antireflection film 15 is formed out of a silicon oxide nitride film by a plasma CVD process, for example, and its suitable thickness is about 40 nm. Alternatively, the antireflection film 15 may be formed using an organic film by a coating process; in that case, its suitable thickness is about 80 nm. Subsequently, a resist film 16A that is sensitive to ArF excimer laser and has a thickness of about 400 nm is applied to the antireflection film 15, a photomask (not shown) in which a circuit pattern for a semiconductor device is formed is properly positioned above the resist film 16A, and then the resist film 16A is exposed to an exposure light that has been passed through the photomask.

Next, as shown in FIG. 9(b), the exposed resist film 16A is developed to provide a resist pattern 16. Also in this embodiment, each cross section of the resist pattern 16A shown is extending perpendicularly to a radial direction of the wafer 11.

Then, as shown in FIG. 9(c), the wafer 11 provided with the resist pattern 16 is placed in the dry etching apparatus, and the antireflection film 15 and the silicon nitride film 14 are dry-etched by using the resist pattern 16 as an etching mask. An etching gas utilized in this case is a gas mixture containing oxygen (O₂), trifluoromethane (CHF₃) and argon (Ar), for example.

The ratio between a reactive gas and a non-reactive gas for diluting the reactive gas, i.e., the value obtained from (O₂+CHF₃)/Ar, is adjusted in the range of 0.02 to 0.1, while the ratio between oxygen and trifluoromethane, i.e., the value obtained from (O₂/CHF₃), is adjusted in the range of 0.1 to 1.

The pressure in the reaction chamber 51 is adjusted in the range of 0.5 Pa to 4 Pa, the electric power for UHF wave generated by the electromagnetic wave generator 60 is adjusted in the range of 200 W to 1000 W, the RF electrical power applied to the upper electrode 53 is adjusted in the range of 100 W to 800 W, and the RF electrical power applied to the lower electrode 55 is adjusted in the range of 50 W to 800 W.

The temperature of the lower electrode 55 is adjusted in the range of −20° C. to 40° C., the temperature of wall face of the reaction chamber 51 is adjusted in the range of 0° C. to 60° C., and the distance between the upper electrode 53 and the lower electrode 55 is adjusted in the range of 10 mm to 120 mm.

In the second embodiment, an etching condition is set so that a pattern shift is about −10 nm.

In the following, exemplary specifics of the etching condition are enumerated.

| | |
|---|---|
| Flow rate of reactive gas (CHF₃): | 60 ml/min |
| Flow rate of reactive gas (O₂): | 20 ml/min |
| Flow rate of dilution gas (Ar): | 1000 ml/min |
| Pressure in reaction chamber: | 2 Pa |
| Electric power for UHF wave: | 600 W |
| RF electrical power to upper electrode: | 400 W |
| RF electrical power to lower electrode: | 200 W |
| Temperature of lower electrode: | 20° C. |
| Temperature of wall face of reaction chamber: | 30° C. |
| Distance between electrodes: | 90 mm |

By employing this etching condition, substantially no deposits are adhered to both sidewalls of the resist pattern 16 as shown in FIG. 9(c).

Consequently, as show in FIG. 9(d), even if the resist pattern 16 is contracted due to exposure to ions during the etching, contraction stresses applied to the resist pattern 16 are in balance at both side faces thereof, and thus no resist tilting occurs.

Furthermore, even if the pattern shift value is larger than −10 nm in absolute value, it is possible to prevent the resist tilting by modifying a parameter value in the etching condition within a predetermined adjustment range, and therefore, a desired pattern size is realized.

### Third Embodiment

Hereinafter, with reference to the drawings, description will be made about a third embodiment of the present invention, i.e., a patterning method in which the dry etching apparatus shown in FIG. 7 is used and a resist pattern with a line width of 100 nm is utilized, thereby forming, out of films to be etched, a circuit pattern with a pattern shift value of about 0 nm.

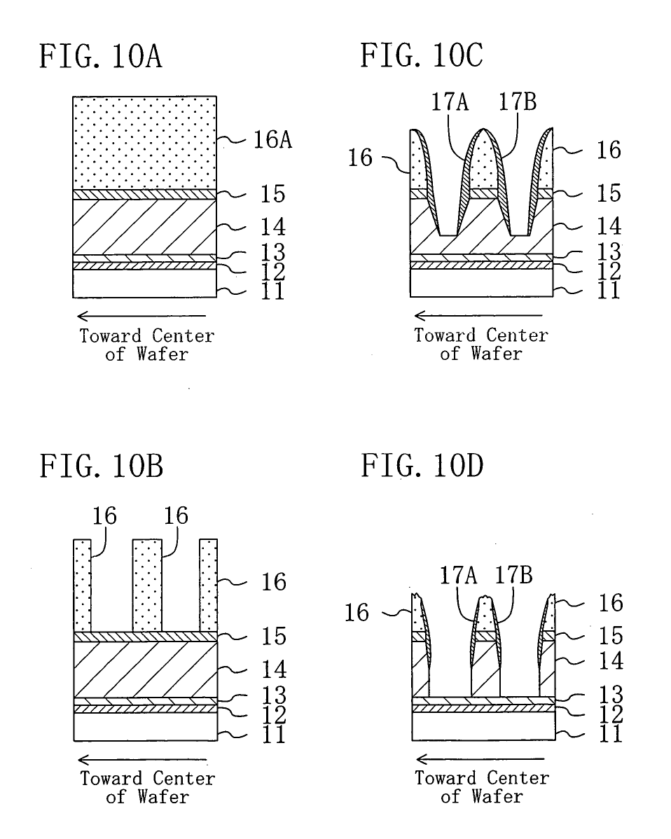

FIGS. 10(a) through 10(d) show partial cross-sections of a wafer for sequentially illustrating respective steps of the patterning method according to the third embodiment of the present invention.

First, as shown in FIG. 10(a), a thermal oxidation or vapor phase epitaxy process, for example, is carried out to form a silicon oxide film 12 with a thickness of about 20 nm on a wafer 11 made of silicon, and then a CVD process, for example, is performed to sequentially deposit, over the silicon oxide film 12, a polysilicon film 13 with a thickness of about 20 nm and a silicon nitride film 14 with a thickness of about 100 nm. Thereafter, on the silicon nitride film 14, an antireflection film 15 for preventing reflection of an exposure light is formed. The antireflection film 15 is formed out of a silicon oxide nitride film by a plasma CVD process, for example, and its suitable thickness is about 35 nm. Alternatively, the antireflection film 15 may be formed using an organic film by a coating process; in that case, its suitable thickness is about 80 nm. Subsequently, a resist film 16A that is sensitive to ArF excimer laser and has a thickness of about 400 nm is applied to the antireflection film 15, a photomask (not shown) in which a circuit pattern for a semiconductor device is formed is properly positioned above the resist film 16A, and then the resist film 16A is exposed to an exposure light that has been passed through the photomask.

Next, as shown in FIG. 10(b), the exposed resist film 16A is developed to provide a resist pattern 16. Also in this embodiment, each cross section of the resist pattern 16A shown is extending perpendicularly to a radial direction of the wafer 11.

Then, as shown in FIG. 10(c), the wafer 11 provided with the resist pattern 16 is placed in the dry etching apparatus, and the antireflection film 15 and the silicon nitride film 14 are dry-etched by using the resist pattern 16 as an etching mask. In the third embodiment, at a time when the etching of the silicon nitride film 14 is progressed about 70 nm, the etching of the silicon nitride film 14 is temporarily stopped. An etching gas utilized in this case is, like the first embodiment, a gas mixture containing sulfur hexafluoride (SF₆), trifluoromethane (CHF₃) and argon (Ar), for example.

The ratio between a reactive gas and a non-reactive gas for diluting the reactive gas, i.e., the value obtained from (SF₆+CHF₃)/Ar, is adjusted in the range of 0.04 to 0.1, while the ratio between sulfur hexafluoride and trifluoromethane, i.e., the value obtained from (SF₆/CHF₃), is adjusted in the range of 1 to 2.5.

The pressure in the reaction chamber 51 is adjusted in the range of 0.5 Pa to 4 Pa, the electric power for UHF wave generated by the electromagnetic wave generator 60 is adjusted in the range of 200 W to 1000 W, the RF electrical power applied to the upper electrode 53 is adjusted in the range of 100 W to 800 W, and the RF electrical power applied to the lower electrode 55 is adjusted in the range of 50 W to 800 W.

The temperature of the lower electrode 55 is adjusted in the range of −20° C. to 40° C., the temperature of wall face of the reaction chamber 51 is adjusted in the range of 0° C. to 60° C., and the distance between the upper electrode 53 and the lower electrode 55 is adjusted in the range of 10 mm to 120 mm.

In a first stage of the etching process which leaves a lower portion of the silicon nitride film 14, an etching condition in which a pattern shift is equal to or larger than 30 nm is employed as in the first embodiment.

For example, if the pattern shift is 30 nm, the etching condition is as follows.

| | |
|---|---|
| Flow rate of reactive gas (SF₆): | 40 ml/min |
| Flow rate of reactive gas (CHF₃): | 20 ml/min |
| Flow rate of dilution gas (Ar): | 1000 ml/min |
| Pressure in reaction chamber: | 2 Pa |
| Electric power for UHF wave: | 600 W |
| RF electrical power to upper electrode: | 400 W |
| RF electrical power to lower electrode: | 150 W |
| Temperature of lower electrode: | 20° C. |
| Temperature of wall face of reaction chamber: | 30° C. |
| Distance between electrodes: | 30 mm |

By employing this etching condition, a first deposit 107A deposited on an inward side face of the resist pattern 16 and a second deposit 17B deposited on an outward side face of the resist pattern 16 are both relatively thickly adhered as shown in FIG. 10(c).

Next, as shown in FIG. 10(d), the etching of the remaining portion of the silicon nitride film 14 is resumed under the condition that the first deposit 17A and the second deposit 17B do not adhere, i.e., under the condition that these deposits 17A and 17B are etched, or in other words, under the etching condition that the pattern shift becomes negative, thereby forming a desired circuit pattern out of the silicon nitride film 14. An etching gas utilized in this case is, like the second embodiment, a gas mixture containing oxygen (O₂), trifluoromethane (CHF₃) and argon (Ar), for example.

The ratio between a reactive gas and a non-reactive gas for diluting the reactive gas, i.e., the value obtained from (O₂+CHF₃)/Ar, is adjusted in the range of 0.02 to 0.1, while the ratio between oxygen and trifluoromethane, i.e., the value obtained from (O₂/CHF₃), is adjusted in the range of 0.1 to 1.

In the third embodiment, each etching parameter value is modified so that about 0 nm is obtained as the final pattern shift value. For example, in a second stage of the etching process, each etching parameter value is set so that the pattern shift is equal to or greater than −30 nm.

In the following, exemplary specifics of the etching condition are enumerated.

| | |
|---|---|
| Flow rate of reactive gas (O₂): | 30 ml/min |
| Flow rate of reactive gas (CHF₃): | 60 ml/min |
| Flow rate of dilution gas (Ar): | 1000 ml/min |
| Pressure in reaction chamber: | 2 Pa |
| Electric power for UHF wave: | 400 W |
| RF electrical power to upper electrode: | 400 W |
| RF electrical power to lower electrode: | 300 W |
| Temperature of lower electrode: | 20° C. |
| Temperature of wall face of reaction chamber: | 30° C. |
| Distance between electrodes: | 30 mm |

In this manner, according to the third embodiment in which the pattern shift value becomes substantially 0 nm, the silicon nitride film 14 is etched in the first stage of the etching process so that the pattern shift is temporarily increased in positive value as shown in FIG. 10(c), and then the silicon nitride film 14 is etched in the second stage of the etching process so that the pattern shift becomes negative, thus making it possible to prevent the resist tilting; therefore, it becomes possible to obtain a circuit pattern in which the pattern shift is substantially 0.

Likewise, if a desired pattern shift value is 0 nm to 30 nm, it is recommendable to modify a parameter value in each stage of the etching process so that the sum of the positive pattern shift value in the first stage and the negative pattern shift value in the second stage becomes the desired pattern shift value.

It should be noted that by contrast to the third embodiment, etching in which the pattern shift temporarily becomes a negative value, i.e., etching in which no deposits are deposited on both side faces of the resist pattern 16, may be performed in the first stage of the etching process, and then etching in which the pattern shift becomes a positive value, i.e., etching in which relatively thick deposits 17A and 17B are deposited on both side faces of the resist pattern 16, may be performed in the second stage of the etching process. In that case, by selecting the etching condition in which the sum of the pattern shift in the first stage and the pattern shift in the second stage becomes a desired value, it becomes possible to prevent the resist tilting. As a result, a circuit pattern having a desired size can be formed with certainty.

Further, although a gas mixture containing sulfur hexafluoride (SF₆), trifluoromethane (CHF₃) and argon (Ar) is utilized as the etching gas for increasing the width, i.e., the thickness, of the resist pattern 16 by deposits in each of the first and third embodiments, trifluoromethane (CHF₃) does not necessarily have to be used. The similar effects can also be obtained by utilizing methane (CH₄), tetrafluorocarbon (CF₄), fluorocarbon (CₓF_{y}) such as C₄F₈, C₂F₆, C₄F₆ or C₅F₈, or hydrofluorocarbon (CHₓF_{y}, where 0≦x, y ≦4, and x+y=4) such as difluoromethane (CH₂F₂). It should be noted that as for CHₓF_{y}, the lower the hydrogen composition ₓ, the greater the etching action against the silicon nitride film 14, whereas the higher the composition ₓ, the larger the amount of deposits. Herein, SF₆ is an etchant for etching silicon nitride and sidewall deposits. Furthermore, as the dilution gas, an inert gas such as helium (He), neon (Ne) or xenon (Xe) may be used instead of argon (Ar).

Besides, in each of the second and third embodiments, as the etching gas that does not allow the deposition of deposits on the side faces of the resist pattern 16, a gas mixture containing oxygen (O₂), trifluoromethane (CHF₃) and argon (Ar) is utilized. However, the similar effects can also be obtained by utilizing a gas such as ozone (O₃), carbon monoxide (CO) or carbon dioxide (CO₂) instead of oxygen (O₂). Oxygen atoms serve as an etchant for etching the sidewall deposits. In addition, fluorocarbons (CHₓF_{y}, CₓF_{y}) may be used instead of trifluoromethane (CHF₃).

Further, other than the combination of oxygen (O₂), trifluoromethane (CHF₃) and argon (Ar), the combination of sulfur hexafluoride (SF₆) and argon (Ar), or the combination of tetrafluorocarbon (CF₄) and argon (Ar) may also be used. Furthermore, sulfur hexafluoride (SF₆) and oxygen may be added at the same time because sulfur hexafluoride etches both of the films to be etched and deposits.

Moreover, although silicon nitride is used for the film to be etched, the similar effects can also be obtained even if silicon oxide is used. Besides, silicon compound does not necessarily have to be used, and if an appropriate etching gas is selected, various semiconductor materials, conductive materials and insulating materials which are suitable for semiconductor fabrication process are applicable.

In addition, in each of the foregoing embodiments, etching is performed using the dry etching apparatus that is shown in FIG. 7 and that employs UHF-ECR plasma technique. The similar effects can naturally be obtained by using, instead of this apparatus, a dry etching apparatus that employs RIE (Reactive Ion Etching), ICP (Inductively Coupled Plasma) or TCP (Transformer Coupled Plasma) technique, or a dry etching apparatus having a plasma source such as DPS (Decoupled Plasma Source), for example.

Further, although a resist sensitive to ArF excimer laser is used as a material for the resist film 16A in each of the foregoing embodiments, the present invention is not limited to this. In other words, as long as a resist material sensitive to ArF excimer laser or an exposure light having a wavelength shorter than that of ArF excimer laser is used, the similar effects can be obtained. To be more specific, the similar effects can be achieved as long as a resist material that does not include benzene ring-containing resin such as novolac or a resist material for forming a pattern with a line width smaller than 130 nm, which has a strength substantially equal to that of a resist material sensitive to ArF excimer laser, is used.

What is claimed is:

1. A patterning method comprising:
a first step of forming a film to be etched over a wafer;
a second step of providing, on the film to be etched, a resist pattern formed out of a resist material sensitive to ArF excimer laser light or an exposure light having a wavelength shorter than that of ArF excimer laser light; and
a third step of etching the film to be etched by using the resist pattern as a mask,
wherein in the third step, the film to be etched is etched while relatively thick deposits are being deposited on both side faces of the resist pattern which are at least perpendicular to a radial direction of the wafer.

2. The patterning method of claim 1,
wherein in the third step, the etching is performed so that a pattern size obtained after the etching of the film to be etched is larger than a predetermined size.

3. The patterning method of claim 2,
wherein a pattern shift resulting from the etching of the film to be etched is +20% to +80%.

4. The patterning method of claim 1,
wherein the film to be etched is made of silicon, silicon compound, carbon or carbon compound, and
wherein in performing the etching while depositing the relatively thick deposits in the third step,
SF₆ is used as a first etching gas for allowing the etching to proceed,
at least one of CF₄, CHF₃, CH₂F₂ and CH₄ is used as a second etching gas for producing the deposits on the side faces of the resist pattern, and
Ar, He, Ne or Xe is used as a dilution gas for diluting the first etching gas and the second etching gas.

5. A patterning method comprising:
a first step of forming a film to be etched over a wafer;
a second step of providing, on the film to be etched, a resist pattern formed out of a resist material sensitive to ArF excimer laser light or an exposure light having a wavelength shorter than that of ArF excimer laser light; and
a third step of etching the film to be etched by using the resist pattern as a mask,
wherein in the third step, the film to be etched is etched so that no deposits are deposited on both side faces of the resist pattern which are at least perpendicular to a radial direction of the wafer.

6. The patterning method of claim 5,
wherein in the third step, the etching is performed so that a pattern size obtained after the etching of the film to be etched is smaller than a predetermined size.

7. The patterning method of claim 6,
wherein a pattern shift resulting from the etching of the film to be etched is +0% to −30%.

8. The patterning method of claim 5,
wherein the film to be etched is made of silicon, silicon compound, carbon or carbon compound, and
wherein in performing the etching so that no deposits are deposited in the third step,
etching gases used include: a first etching gas for allowing the etching to proceed; a second etching gas for allowing the etching to proceed and for producing the deposits; a third etching gas for producing the deposits; and a fourth etching gas for etching the deposits,
a first gas mixture provided by the combination of: the first or second etching gas; the third etching gas; and the fourth etching gas, or a second gas mixture provided by the combination of: the first or second etching gas; and the fourth etching gas is used,
the first etching gas is SF₆, the second etching gas is CF₄ or CHF₃, the third etching gas is at least one of CH₂F₂ and CH₄, and the fourth etching gas is at least one of SF₆, O₂, O₃, CO and C0₂, and
Ar, He, Ne or Xe is used as a dilution gas for diluting the first gas mixture and the second gas mixture.

9. A patterning method comprising:
a first step of forming a film to be etched;
a second step of providing, on the film to be etched, a resist pattern formed out of a resist material sensitive to ArF excimer laser light or an exposure light having a wavelength shorter than that of ArF excimer laser light; and
a third step of etching the film to be etched by using the resist pattern as a mask,
wherein the third step comprises the steps of:
(a) etching the film to be etched while depositing relatively thick deposits on both side faces of the resist pattern; and
(b) etching the film to be etched so that no deposits are deposited on said both side faces of the resist pattern.

10. The patterning method of claim 9,
wherein the film to be etched is formed over a wafer, and
wherein said both side faces of the resist pattern are at least perpendicular to a radial direction of the wafer.

11. The patterning method of claim 10,
wherein in the step (a) of the third step, the etching is performed so that a pattern size obtained after the etching of the film to be etched is larger than a predetermined size, and
wherein in the step (b) of the third step, an etching condition for the film to be etched is set so that the deposits are etched, and the etching is performed so that the pattern size obtained after the etching of the film to be etched is smaller than a predetermined size.

12. The patterning method of claim 11,
wherein a pattern shift resulting from the etching of the film to be etched is ±0% to +20%.

13. The patterning method of claim 9,
wherein the film to be etched is made of silicon, silicon compound, carbon or carbon compound, and
wherein in performing the etching while depositing the relatively thick deposits in the third step,
SF₆ is used as a first etching gas for allowing the etching to proceed,
at least one of CF₄, CHF₃, CH₂F₂ and CH₄ is used as a second etching gas for producing the deposits on the side faces of the resist pattern, and
Ar, He, Ne or Xe is used as a dilution gas for diluting the first etching gas and the second etching gas.

14. The patterning method of claim 9,
wherein the film to be etched is made of silicon, silicon compound, carbon or carbon compound, and
wherein in performing the etching so that no deposits are deposited in the third step,
etching gases used include: a first etching gas for allowing the etching to proceed; a second etching gas for allowing the etching to proceed and for producing the deposits; a third etching gas for producing the deposits; and a fourth etching gas for etching the deposits,
a first gas mixture provided by the combination of: the first or second etching gas; the third etching gas; and the fourth etching gas, or a second gas mixture provided by the combination of: the first or second etching gas; and the fourth etching gas is used,
the first etching gas is SF₆, the second etching gas is CF₄ or CHF₃, the third etching gas is at least one of CH₂F₂ and CH₄, and the fourth etching gas is at least one of SF₆, O₂, O₃, CO and C0₂, and
Ar, He, Ne or Xe is used as a dilution gas for diluting the first gas mixture and the second gas mixture.
